(19) United States
(12) Patent Application Publication
(10) Pub. No.: US 2007/0070974 A1
(43) Pub. Date: Mar. 29, 2007

(54) Event delivery in switched fabric networks

(76) Inventors: Mo Rooholamini, Gilbert, AZ (US); Randeep Kapoor, Gilbert, AZ (US); Ward McQueen, Chandler, AZ (US)

Correspondence Address: FISH & RICHARDSON, PC, P.O. BOX 1022, MINNEAPOLIS, MN, 55440-1022, US

(21) Appl. No.: 11/241,798

(22) Filed: Sep. 29, 2005

(51) Int. Cl. H04L 12/28; H04L 12/56

(52) U.S. Cl. 370/351; 370/400

(57) ABSTRACT

In a switched fabric network that handles communication between a first event-generating device, a second event-generating device, and an event-processing device, and in which the first and second event-generating devices are coupled by a link of the fabric, methods and apparatus, including computer program products, implementing techniques for providing a path between the first event-generating device and the event-processing device to communicate a link event generated at the first event-generating device to the event-processing device without passing over the link between the first and second event-generating devices.

### BACKGROUND

This description relates to event delivery in switched fabric networks.

Advanced Switching Interconnect (ASI) is a technology based on the Peripheral Component Interconnect Express (PCI Express) architecture and enables standardization of various backplanes. The Advanced Switching Interconnect Special Interest Group (ASI-SIG) is a collaborative trade organization chartered with providing a switching fabric interconnect standard, specifications of which, including the Advanced Switching Core Architecture Specification, Revision 1.1, November 2004 (available from the ASI-SIG at www.asi-sig.com), it provides to its members.

ASI utilizes a packet-based transaction layer protocol that operates over the PCI Express physical and data link layers. The ASI architecture provides a number of features common to multi-host, peer-to-peer communication devices such as blade servers, clusters, storage arrays, telecom routers, and switches. These features include support for hot adding and removal of boards, redundant pathways, and fabric management fail-over.

The ASI architecture defines an event notification protocol that enables an ASI device (e.g., an ASI endpoint, switch, or bridge) to notify an agent of a condition that has been detected by the device. Such conditions include conditions associated with requests at the packet origin, packets flowing through a switch, packet delivery at the destination, or a change in device hardware state (i.e., an error condition). The number of conditions varies from device to device.

Generally, when an ASI device detects a condition that warrants sending an event, the event is sent to an event handler identified in the ASI Event Capability Structure of the device, or if the event is related to a problem with a specific forward routed packet, the event is sent to the packet origin if an event table is so configured. In the former case, each event (or class of events) is associated with a path (“event path”) specified in a register of the device's ASI Event Capability Structure. The register defines path information that is used by the device to build an event packet to be sent to the event handler. There may be instances in which two ASI devices are configured with event paths that route events over the link connecting the two ASI devices. Problems arise when the device connecting link fails or is removed for any reason, as the events generated by the two ASI devices are routed through the removed/failed link. Consequently, the event handler remains unaware of the detected condition and does not take any corrective action. This may result in an instability in the fabric, which is detrimental to its operation.

### BRIEF DESCRIPTION OF THE DRAWINGS

FIG. 1 is a block diagram of a switched fabric network.

FIG. 2 is a diagram of protocol stacks.

FIG. 3 is a diagram of an ASI transaction layer packet (TLP) format.

FIG. 4 is a block diagram of a switched fabric network with event paths.

FIG. 5 shows a flowchart of a path defining process at a fabric-managing device of the switched fabric network.

### DETAILED DESCRIPTION

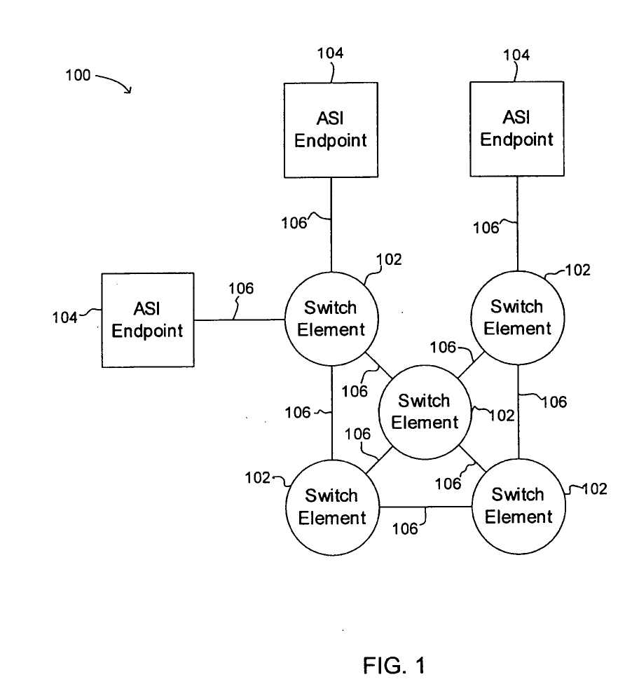

Referring to FIG. 1, an Advanced Switching Interconnect (ASI) switched fabric network 100 includes ASI devices interconnected via links. The ASI devices that constitute internal nodes of the network 100 are referred to as “switch elements” 102 and the ASI devices that reside at the edge of the network 100 are referred to as “end points” 104. The switch elements 102 and the links form a switch fabric. Other ASI devices (not shown) may be included in the network 100. Such ASI devices can include ASI bridges that connect the network 100 to other communication infrastructures, e.g., PCI Express fabrics.

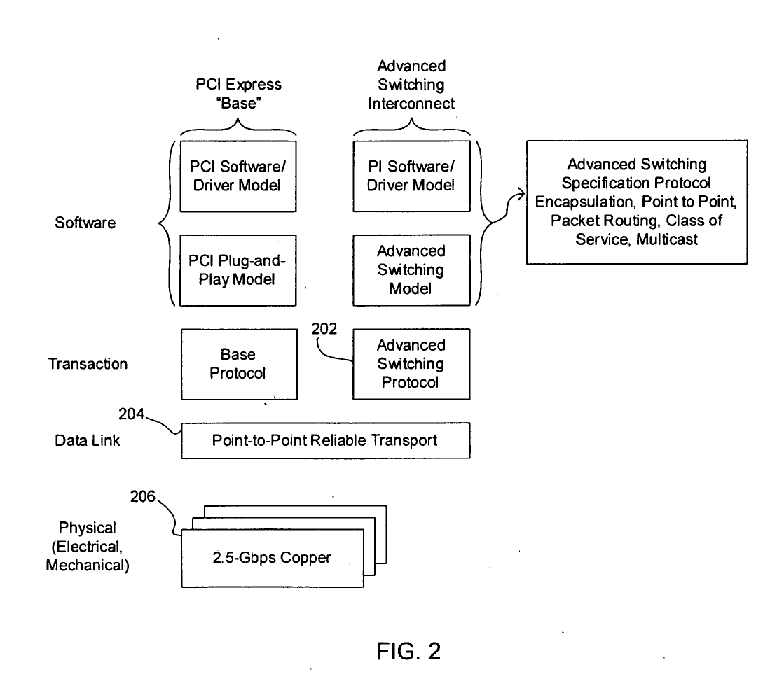

Each ASI device 102, 104 has an ASI interface that is part of the ASI architecture defined by the Advanced Switching Core Architecture Specification (“ASI Specification”). The ASI architecture utilizes a packet-based transaction layer protocol 202 that operates over the PCI Express physical and data link layers 204, 206, as shown in FIG. 2.

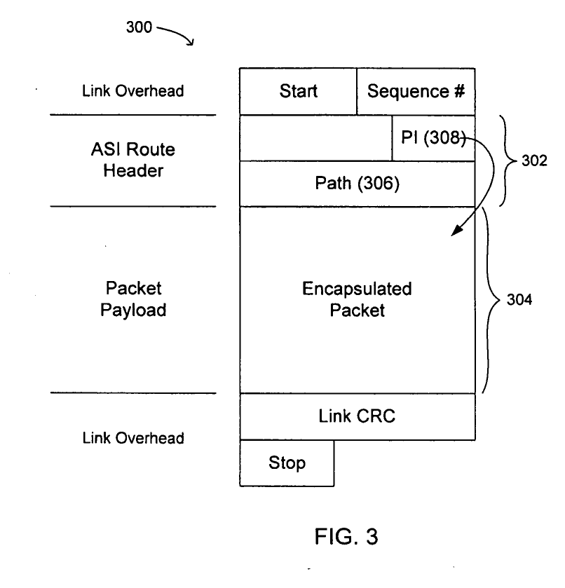

ASI uses a path-defined routing methodology in which the source of a packet provides all information required by a switch (or switches) to route the packet to the desired destination. FIG. 3 shows an ASI transaction layer packet (TLP) format 300. The packet includes a route header 302 and an encapsulated packet payload 304. The ASI route header 302 contains path information 306 that is necessary to route the packet through an ASI fabric, and a field 308 that specifies the Protocol Interface (PI) of the encapsulated packet. ASI switch elements route packets using the information contained in the ASI route header 302 without necessarily requiring interpretation of the contents of the encapsulated packet 304.

The PI field 308 in the ASI route header 302 determines the format of the encapsulated packet 304. The PI field 308 is inserted by the ASI end point 104 that originates the ASI packet and is used by the ASI end point 104 that terminates the packet to correctly interpret the packet contents. The separation of routing information from the remainder of the packet enables an ASI fabric to tunnel packets of any protocol.

PIs represent fabric management and application-level interfaces to the switched fabric network 100. Table 1 provides a list of PIs currently supported by the ASI Specification.

TABLE 1
ASI protocol interface IDs

| PI Index | Protocol Interface |
|---|---|
| 0 | Path Building |
| (0:0) | (Spanning Tree Generation) |
| (0:1-0:126) | (Multicast) |
| 1 | Congestion Management (Flow ID messaging) |
| 2 | Transport Services |
| 3 | Reserved |
| 4 | Device Management |
| 5 | Event Reporting |
| 6 | Reserved |
| 7 | Reserved |
| 8-95 | ASI-SIG defined PIs |
| 96-126 | Vendor-defined PIs |
| 127 | Invalid |

PIs 0-7 are used for various fabric management tasks, and PIs 8-126 are application-level interfaces.

The ASI architecture supports the implementation of an ASI Configuration Space in each ASI device 102, 104 of the network. The ASI Configuration Space is a storage area that includes fields to specify device characteristics as well as fields used to control the ASI device. The ASI Configuration Space includes up to 16 apertures where configuration information can be stored. Each aperture includes up to 4 Gbytes of storage and is 32-bit addressable. The configuration information is presented in the form of capability structures and other storage structures, such as tables and a set of registers. One of the capability structures defined by the ASI Specification and stored in aperture 0 of the ASI Configuration Space is the ASI Event Capability Structure. The ASI Event Capability Structure can be accessed through node configuration packets, e.g., PI-4 packets, as described in more detail below.

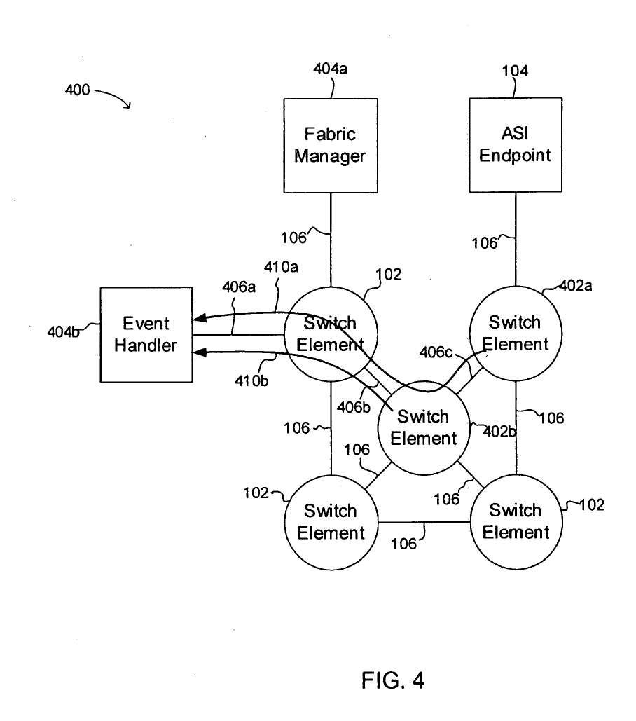

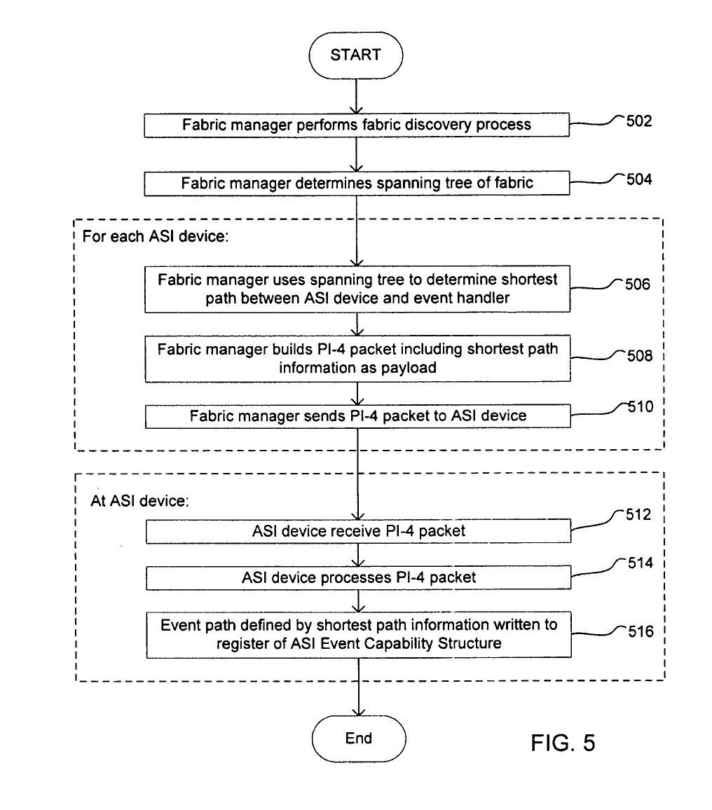

Referring to FIGS. 4 and 5, any ASI end point 104 that hosts fabric-management software 404a in its memory 450 can be elected as a fabric manager. The fabric manager election is an arbitration process that may be initiated by a variety of either hardware or software mechanisms to elect the fabric manager(s) for the switched fabric network 400. Once elected, a fabric manager “owns” all of the ASI devices 102, 104, including itself, in the network 400. If multiple fabric managers, e.g., a primary fabric manager and a secondary fabric manager, are elected, then each fabric manager may own a subset of the ASI devices in the network 400. Alternatively, the secondary fabric manager may declare ownership of the ASI devices in the network upon a failure of the primary fabric manager, e.g., resulting from a fabric redundancy and fail-over mechanism.

Once a fabric manager declares ownership, it has privileged access to the ASI Configuration Space of each of its ASI devices 102, 104. The fabric manager utilizes its ability to read and write to the ASI Configuration Space of each of its ASI devices 102, 104 to perform (502) a fabric discovery process, in which the fabric manager records which ASI devices 102, 104 are connected, collects information about each ASI device 102, 104 in the network, and constructs a topology of the fabric. The fabric manager then uses a spanning tree algorithm to determine a spanning tree of the fabric.

For each ASI device 102, 104 in the network 400, the fabric manager uses the spanning tree to determine (506) a shortest path between the ASI device 102, 104 and an ASI end point that has been designated as an event handler for the fabric. Generally, any ASI end point 104 that has an event handler software 404b in its memory 460 can be designated as the event handler for the fabric. The fabric manager then builds (508) a PI-4 write packet having a packet header that specifies an aperture number and address corresponding to a register of the ASI device's ASI Event Capability Structure, and a payload that specifies path information defined by the shortest path between the ASI device 102, 104 and the event handler. The PI-4 packet is then sent (510) by the fabric manager to the ASI device 102, 104.

Upon receipt (512) of the PI-4 write packet, the ASI device 102, 104 processes (514) a write command to write data extracted from the payload of the PI-4 write packet to the register specified in the PI-4 packet header. In so doing, the event path specified (516) in the register of the ASI Event Capability Structure is defined by the shortest path information.

Two event paths 410a, 410b are depicted in the illustrated example of FIG. 4. The event path 410a for ASI switch element 402a includes links 406a, 406b, 406c, and the event path 410b for ASI switch element 402b includes links 406a, 406b. As can be seen, the event paths 410a, 410b for the ASI devices 402a, 402b share a number of common links, namely links 406a, 406b. Notably, the link (“device connecting link” 406c) connecting the ASI switch elements 402a, 402b is only present in one of the event paths 410b.

In a scenario in which the device connecting link 406c fails or is removed for any reason, both of the ASI switch elements 402a, 402b will each independent of the other detect the link failure/removal condition, generate a corresponding link event, and attempt to send the link event to the event handler for processing. By configuring the two ASI devices 402a, 402b such that the event paths 410a, 410b do not both include the device connecting link 406c, a link event generated by at least one ASI device (in this case, the ASI switch element 402b) is guaranteed to be delivered successfully to the event handler. In so doing, corrective action can be taken by the event handler, thus preserving the stability of the fabric.

The techniques of one embodiment of the invention can be performed by one or more programmable processors executing a computer program to perform functions of the embodiment by operating on input data and generating output. An apparatus of one embodiment of the invention can be implemented as special purpose logic circuitry, e.g., one or more FPGAs (field programmable gate arrays) and/or one or more ASICs (application specific integrated circuits).

Processors suitable for the execution of a computer program include, by way of example, both general and special purpose microprocessors, and any one or more processors of any kind of digital computer. Generally, a processor will receive instructions and data from a memory (e.g., memory 450, 460 of FIG. 4). The memory may include a wide variety of memory media including but not limited to volatile memory, non-volatile memory, flash, programmable variables or states, random access memory (RAM), read-only memory (ROM), flash, or other static or dynamic storage media. In one example, machine-readable instructions or content can be provided to the memory from a form of machine-accessible medium. A machine-accessible medium may represent any mechanism that provides (i.e., stores or transmits) information in a form readable by a machine (e.g., an ASIC, special function controller or processor, FPGA or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like. The processor and the memory can be supplemented by, or incorporated in special purpose logic circuitry.

The invention has been described in terms of particular embodiments. Other embodiments are within the scope of the following claims. For example, the steps of an implementation of the invention can be performed in a different order and still achieve desirable results.

What is claimed is:

1. A method comprising:
in a switched fabric network that handles communication between a first event-generating device, a second event-generating device, and an event-processing device, and in which the first and second event-generating devices are coupled by a link of the fabric, providing a path between the first event-generating device and the event-processing device to communicate a link event generated at the first event-generating device to the event-processing device without passing over the link between the first and second event-generating devices.

2. The method of claim 1, further comprising:
at the first event-generating device, detecting a condition of the link between the first and second event-generating devices, and generating a link event based on the detection.

3. The method of claim 1, wherein the condition comprises one of a failure of the link and a removal of the link.

4. The method of claim 1, further comprising:
providing a path between the second event-generating device and the event-processing device for use in communicating a link event generated at the second event-generating device to the event-processing device.

5. The method of claim 4, wherein the path between the second event-generating device and the event-processing device includes the link between the first and second event-generating devices.

6. The method of claim 1, wherein the link event notifies the event-processing device of a condition of the link between the first and second event-generating devices.

7. The method of claim 1, wherein the switched fabric network comprises an Advanced Switching Interconnect (ASI) fabric, the first or second event-generating device comprises an ASI end point or an ASI switch, and the event-processing device comprises an ASI end point.

8. The method of claim 1, wherein the providing comprises:
determining a topology of the fabric;
generating a spanning tree of the fabric based on the topology; and
determining a shortest path between the first event-generating device and the event-processing device based on the spanning tree.

9. The method of claim 1, wherein providing the path comprises writing data to an address location in a memory space of the first event-generating device.

10. The method of claim 9, wherein the memory space of the first event-generating device comprises an event capability register of an Advanced Switching Interconnect (ASI) event capability structure.

11. A machine-accessible medium comprising content, which, when executed by a machine causes the machine to:
provide a path between a first event-generating device and an event-processing device, the path for use in communicating a link event generated at the first event-generating device to the event-processing device without passing over a link of a switched fabric network that couples the first event-generating device to a second event-generating device.

12. The machine-accessible medium of claim 11, further comprising content, which, when executed by the machine causes the machine to:
provide a path between the second event-generating device and the event-processing device for use in communicating a link event generated at the second event-generating device to the event-processing device.

13. The machine-accessible medium of claim 12, wherein the path between the second event-generating device and the event-processing device comprises the link between the first and second event-generating devices.

14. The machine-accessible medium of claim 11, wherein the content, which, when executed by the machine causes the machine to provide a path comprise content to:
determine a topology of the fabric;
generate a spanning tree of the fabric based on the topology; and
determine a shortest path between the first event-generating device and the event-processing device based on the spanning tree.

15. A switched fabric device comprising:
a processor;
a memory including fabric management software to provide instructions to the processor to:
provide a path between a first event-generating device and an event-processing device of a switched fabric network, the path for use in communicating a link event generated at the first event-generating device to the event-processing device without passing over a link between the first event-generating device and a second event-generating device.

16. The switched fabric device of claim 15, further to provide instructions to the processor to:
provide a path between the second event-generating device and the event-processing device, the path for use in communicating a link event generated at the second event-generating device to the event-processing device.

17. The switched fabric device of claim 16, wherein the path between the second event-generating device and the event-processing device comprises the link between the first and second event-generating devices.

18. The switched fabric device of claim 15, further to provide instructions to the processor to:
determine a topology of the fabric;
generate a spanning tree of the fabric based on the topology; and
determine a shortest path between the first event-generating device and the event-processing device based on the spanning tree.

19. A system comprising:
switch elements of a fabric;
end points interconnected by links of the fabric, the end points including:
a first end point operable to generate a link event;
a second end point operable to generate a link event;
a third end point including an event handler component operable to process link events; and
a fourth end point including a fabric management component operable to provide a path between the first end point, at least one switch element, and the third end point, the path for use in communicating a link event generated at the first end point to the third end point without passing over a link between the first end point and the second end point.

20. The system of claim 19, wherein the fabric management component is further operable to:
determine a topology of the fabric;
generate a spanning tree of the fabric based on the topology; and
determine a shortest path between the first end point and the third end point based on the spanning tree.

21. The system of claim 19, wherein the fabric management component is further operable to provide a path between the second end point, at least one switch element, and the third end point, the path for use in communicating a link event generated at the second end point to the third end point.

22. The system of claim 21, wherein the path between the second end point and the third end point comprises the link between the first and second end points.

23. The system of claim 19, wherein the switch fabric comprises an Advanced Switching Interconnect (ASI) fabric.
